(19) United States
(12) Patent Application Publication
(10) Pub. No.: US 2026/0216596 A1
(43) Pub. Date: Jul. 30, 2026

(54) INTERACTION CONTROL METHOD AND APPARATUS FOR OBJECT MOVEMENT, AND ELECTRONIC DEVICE

(71) Applicant: NETEASE (HANGZHOU) NETWORK CO., LTD., Hangzhou, Zhejiang (CN)

(72) Inventor: Xizi SU, Hangzhou, Zhejiang (CN)

(73) Assignee: NETEASE (HANGZHOU) NETWORK CO., LTD., Hangzhou, Zhejiang (CN)

(21) Appl. No.: 19/143,488

(22) PCT Filed: May 23, 2023
(86) PCT No.: PCT/CN2023/095886

§ 371 Date: Jun. 26, 2025

(30) Foreign Application Priority Data
Dec. 27, 2022 (CN) 202211727682.7

(51) Int. Cl. A63F 13/40; A63F 13/2145

(52) U.S. Cl. CPC A63F 13/40; A63F 13/2145

(57) ABSTRACT

An interaction control method for object movement includes: in response to a first specified touch operation on a virtual joystick, controlling the virtual joystick to move within a movement range of the virtual joystick; based on a first position of the touch point of the first specified touch operation, determining a first movement parameter of a controlled virtual object, and controlling the controlled virtual object to move according to the first movement parameter; in response to the touch point of the first specified touch operation moving from the first position to a second position and the second position fulfilling a preset condition, determining a second movement parameter; and in response to a second specified touch operation, determining an adjustment parameter according to the second specified touch operation; and determining a third movement parameter according to the adjustment parameter and the second movement parameter.

### CROSS-REFERENCE TO RELATED APPLICATION(S)

This application is a U.S. National Stage of International Application No. PCT/CN2023/095886, filed on May 23, 2023, which claims priority to Chinese patent application No. 202211727682.7 filed on Dec. 27, 2022 and entitled “INTERACTION CONTROL METHOD AND APPARATUS FOR OBJECT MOVEMENT AND ELECTRONIC DEVICE”, the entire contents of both of which are incorporated herein by reference in their entirety for all purposes.

### TECHNICAL FIELD

The present disclosure relates to the field of game interaction technologies, and in particular to an interaction control method and apparatus for object movement and an electronic device.

### BACKGROUND

In some game scenarios, a player usually needs to control the movement of a virtual character. In the related art, a joystick control may be set so that the player can control the speed and direction of the virtual character through the joystick control. The joystick control has an original position and a control range with the original position as a center. Within the control range, the farther the player controls the “joystick” from the original position through a touch point of a sliding operation, the faster the movement speed of the virtual character controlled by the player.

### SUMMARY

According to an aspect of the present disclosure, an interaction control method for object movement is provided. The method includes: in response to a first specified touch operation on a virtual joystick displayed on a graphical user interface provided through a terminal device, controlling the virtual joystick to move within a movement range of the virtual joystick according to movement of a touch point of the first specified touch operation; determining a first movement parameter of a controlled virtual object based on a first position of the touch point of the first specified touch operation, and controlling the controlled virtual object to move in a game scene where the controlled virtual is located according to the first movement parameter, where the first movement parameter includes at least one of a movement speed or a movement direction; in response to the touch point of the first specified touch operation moving from the first position to a second position and the second position fulfilling a preset condition, determining a second movement parameter of the controlled virtual object, and controlling the controlled virtual object to move in the game scene according to the second movement parameter in response to the first specified touch operation being released; in response to the second specified touch operation, determining an adjustment parameter according to the second specified touch operation, wherein the second specified touch operation and the first specified touch operation are touch operations that are not continuous; determining a third movement parameter according to the adjustment parameter and the second movement parameter, and controlling the controlled virtual object to move according to the third movement parameter.

According to an aspect of the present disclosure, an electronic device is also provided, including a processor and a memory. The memory stores machine executable instructions that can be executed by the processor, and the processor executes the machine executable instructions to implement the above-mentioned interaction control method for object movement.

According to an aspect of the present disclosure, a non-transitory machine-readable storage medium is also provided, which stores machine-executable instructions. When the machine-executable instructions are invoked and executed by a processor, the machine-executable instructions cause the processor to implement the above-mentioned interaction control method for object movement.

### BRIEF DESCRIPTION OF THE DRAWINGS

FIG. 1 is a flowchart of an interaction control method for object movement according to one of embodiments of the present disclosure;

FIG. 2 is a schematic diagram of a graphical user interface in which a movement region of a virtual joystick is displayed according to one of the embodiments of the present disclosure;

FIG. 3 is a schematic diagram of another graphical user interface in which a movement region of a virtual joystick is displayed according to one of the embodiments of the present disclosure;

FIG. 4 is a schematic diagram of another graphical user interface in which a movement region of a virtual joystick is displayed according to one of the embodiments of the present disclosure;

FIG. 5 is a schematic diagram of a graphical user interface in which a virtual joystick is located at an edge position of a movement region according to one of the embodiments of the present disclosure;

FIG. 6 is a schematic diagram of a graphical user interface in which a virtual joystick is located at an edge position of a movement region according to one of the embodiments of the present disclosure;

FIG. 7 is a schematic diagram of a graphical user interface in which an updated movement region of a virtual joystick is displayed according to one of the embodiments of the present disclosure;

FIG. 8 is a schematic diagram of another graphical user interface in which an updated movement region of a virtual joystick is displayed according to one of the embodiments of the present disclosure;

FIG. 9 is a schematic structural diagram of an interaction control apparatus for object movement according to one of the embodiments of the present disclosure;

FIG. 10 is a schematic structural diagram of an electronic device according to one of the embodiments of the present disclosure.

### DETAILED DESCRIPTION

In order to make the purposes, technical solutions and advantages of the embodiments of the present disclosure clearer, the technical solutions of the present disclosure will be clearly and completely described below in conjunction with the accompanying drawings. Obviously, the described embodiments are a part of the embodiments of the present disclosure, rather than all of the embodiments. Based on the embodiments in the present disclosure, all other embodiments obtained by those skilled in the art without creative work are within the scope of protection of the present disclosure.

In games, there are often racing-related gameplay, such as battling the shrinking safe zone, or tactical retreat, etc. Many players often map the mood of acceleration to the dragging of a virtual joystick. As a result, it often happens that the joystick speed has reached the limit, but the player's finger still moves up. This situation will affect the comfort of the grip of hand and even block key information on the screen.

The judgment mechanism of the virtual joystick is as follows: after the finger leaves the screen, the joystick is reset to a default position, that is, the zero speed position, causing a brief deceleration. Even if the player has entered the “sprint” state before, the joystick is reset to the default position, and the next adjustment needs to start from the middle 0 speed position. When it is needed to maintain speed and advancement direction control, although the player's finger position has left the control region of the virtual joystick, the player dare not release the joystick to adjust the drag position, otherwise it will cause a disadvantage in the battle. In this scenario, the player's advancement at the maximum speed is interrupted, causing discomfort in the experience.

For example, in some cases, due to an inertial operation, the position of the touch point where the player operates the joystick may exceed the control range, causing the player's finger used for operation to approach the top of the screen, affecting the comfort of hand holding and blocking information. If the player wants to lift his/her finger to adjust the position of the touch point to be within the control range, the sliding operation is determined to be over, and the “joystick” returns to its original position, causing the speed of the virtual character to become zero. This method causes the speed of the virtual character to drop rapidly against the player's will, resulting in a poor game experience for the player.

Based on this, the embodiments of the present disclosure provide an interaction control method and apparatus for object movement and an electronic device. This technology may be applied to various game scenarios in which a virtual joystick is used for controlling movement.

In an embodiment of the present disclosure, the interaction control method for object movement may be run on a local terminal device or a server. When the interaction control method for object movement is run on the server, the method may be implemented and carried out based on a cloud interaction system, and the cloud interaction system includes the server and a client device.

In some implementations, various cloud applications may be run under the cloud interaction system, such as cloud games. Taking a cloud game as an example, the cloud game refers to a game mode based on cloud computing. In an operation mode of the cloud game, an entity for operating the game program and an entity for presenting game screen(s) are separated. The storage and operation of the interaction control method for object movement are completed on the cloud game server. The role of the client device is for receiving and sending data and presenting the game screen(s). For example, the client device may be a display device with a data transmission function close to the user side, such as a mobile terminal, a TV, a computer, a handheld computer, etc., but it is the cloud game server in the cloud that is used for information processing. When playing the game, a player operates the client device to send an operation instruction to the cloud game server. The cloud game server runs the game according to the operation instruction, encodes and compresses data such as the game screen(s), and returns the data to the client device through a network. Finally, the client device performs decoding and outputs the game screen(s).

In some implementations, taking a game as an example, a local terminal device stores a game program and is used to present game screen(s). The local terminal device is used to interact with a player through a graphical user interface, that is, the game program is downloaded and installed and run by an electronic device in a conventional manner. The local terminal device may provide the graphical user interface to the player in a variety of ways, for example, the graphical user interface may be rendered and displayed on a display screen of a terminal, or provided to the player through a holographic projection. For example, the local terminal device may include a display screen and a processor, the display screen is used to present a graphical user interface, the graphical user interface includes game screen(s), and the processor is used to run the game, generate the graphical user interface, and control the graphical user interface to be displayed on the display screen.

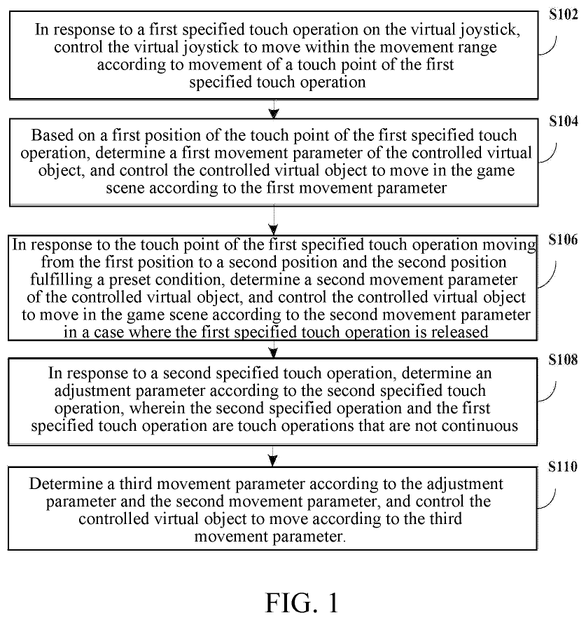

In a possible implementation, an embodiment of the present disclosure provides an interaction control method for object movement. A graphical user interface is provided through a terminal device. The terminal device may be the local terminal device mentioned above, or may be a client device in the cloud interactive system mentioned above. A game scene where a controlled virtual object is located and a movement control are displayed on the graphical user interface. The movement control includes a virtual joystick and a movement region of the virtual joystick. The movement region is used to limit a movement range of the virtual joystick. As shown in FIG. 1, the method includes the following steps:
In step S102, in response to a first specified touch operation on the virtual joystick, the virtual joystick is controlled to move within the movement range according to movement of a touch point of the first specified touch operation.

The virtual joystick is usually used to mimic a real joystick. One end of the real joystick is fixed at an initial position, and the other end may swing with the fixed end as a fixed point under the action of an external force. Since the swing direction and angle of the joystick are limited, the swinging end forms a region based on the swing direction and angle, and the region may be called a movement region. Correspondingly, an initial position and a movement region are usually set for a virtual joystick. When being displayed, the virtual joystick is usually a circular mark, which mimics the movable end of the joystick. The mark of the virtual joystick may move in the movement region following the position of the touch point of the player's touch operation.

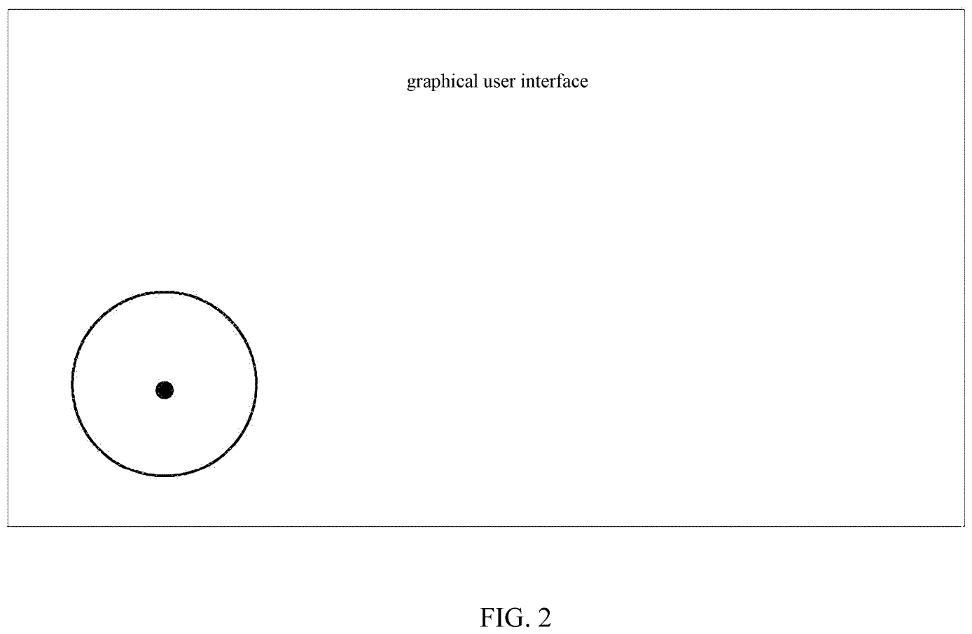

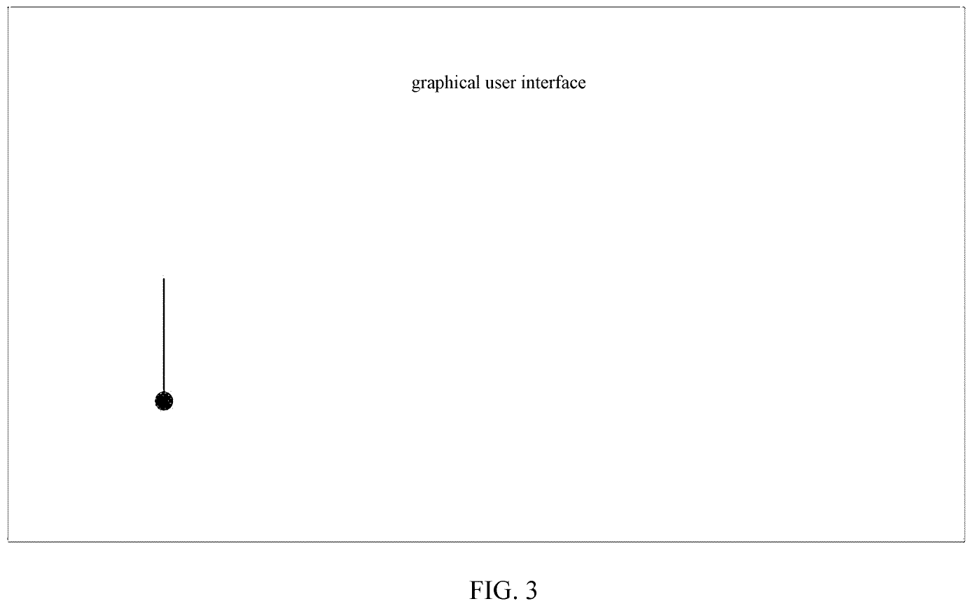

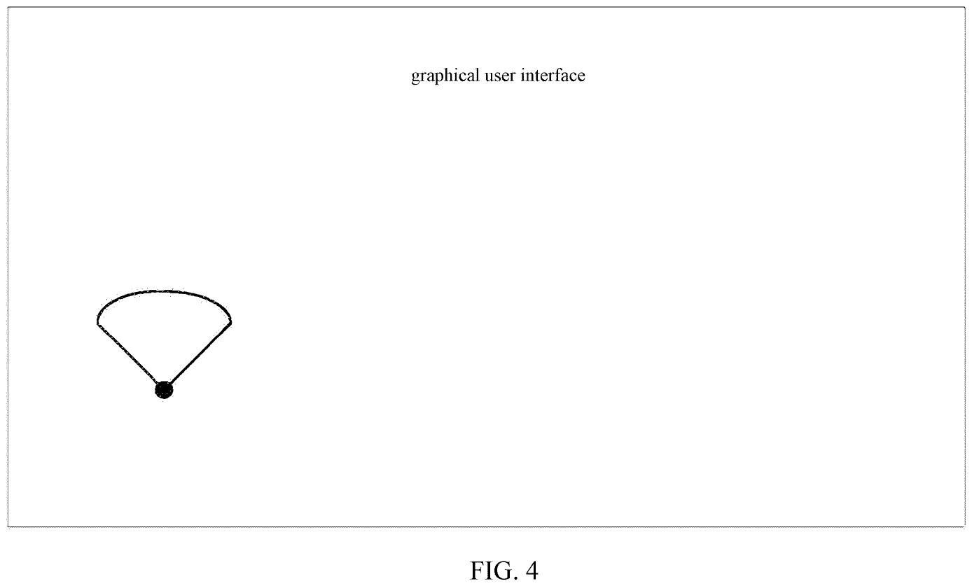

The movement region may be in various shapes, such as a circular region with the initial position as the center as shown in FIG. 2, or a straight line with the initial position as the starting point as shown in FIG. 3, or a sector region with the initial position as the center as shown in FIG. 4. When no operation is imposed on the virtual joystick, the virtual joystick is usually displayed at the initial position.

The first specified touch operation may be a sliding operation with the initial position as a starting point, or may be a sliding operation with the initial position as the starting point after the virtual joystick is activated by long pressing the virtual joystick at the initial position, etc. When the position of the touch point of the first specified touch operation is within the movement region, the position of the virtual joystick coincides with the position of the touch point of the first specified operation, and when the position of the touch point of the first specified operation moves, the virtual joystick moves following the position of the touch point of the first specified touch operation.

The first specified touch operation may also be a sliding operation with a starting point outside the movement region. In some games, in order to cope with a situation where the player does not check the movement region of the virtual joystick but directly performs a sliding operation on the touch screen of the terminal device to control the movement of the controlled virtual object, a part of the graphical user interface may be set to be triggerable. For example, when the virtual joystick is set in the lower left corner of the graphical user interface, the region above the movement region of the virtual joystick on the graphical user interface may be set to be triggerable.

If the player performs a sliding operation in this region, when the player performs a pressing operation, the position of the touch point of the pressing operation may be regarded as the “initial position” of the virtual joystick, and the “initial position” corresponds to the initial position of the virtual joystick displayed on the graphical user interface. Then, based on the “initial position”, a corresponding “movement region” is determined. The size of the “movement region” may be the same as the movement region of the actual displayed virtual joystick, or may also be reduced according to a set ratio. For example, the farther the “initial position” is from the initial position of the actual displayed virtual joystick, the smaller the size of the corresponding “movement region”. That is, the player only needs to perform a sliding operation of a relatively short distance to quickly change the movement parameters of the controlled virtual object.

The above-mentioned “movement region” is usually invisible, but the sliding operation performed by the player in the “movement region” causes the offset of the position of the virtual joystick from its initial position to be reflected in the movement region of the virtual joystick displayed on the graphical user interface. At the same time, the controlled virtual object may also move based on a movement parameter generated based on the offset of the position of the virtual joystick from its initial position.

In step S104, a first movement parameter of the controlled virtual object is determined based on a first position of the touch point of the first specified touch operation, and the controlled virtual object is controlled to move in the game scene according to the first movement parameter. The first movement parameter includes a movement speed and/or a movement direction.

Respective region positions in the above-mentioned movement region usually correspond to different movement parameters. A movement parameter may be a movement speed, a movement direction, or both. When the first position of the touch point of the first specified touch operation is located at a certain region position in the movement region, the movement parameter corresponding to the region position may be determined as the first movement parameter of the controlled virtual object. And, the controlled virtual object is controlled to move in the game scene at the movement speed and/or movement direction corresponding to the first movement parameter.

When the position of the touch point of the first specified touch operation is updated, the first movement parameter corresponding to the controlled virtual object may be updated based on the updated position of the touch point, and the controlled virtual object may be controlled to move according to the updated first movement parameter.

As described above, if the starting position of the touch point of the first specified touch operation is outside the movement region, when the first position of the touch point is within the “movement region” determined based on the starting position, the movement parameter corresponding to the first position in the “movement region” may be determined as the first movement parameter of the controlled virtual object. For the case where the starting position of the touch point of the first specified touch operation is outside the movement region, the starting position may be used to mimic the “initial position” of the virtual joystick, and the “movement region” may be determined. Then, during the movement of the position of the touch point, the corresponding movement parameter may be determined based on the “initial position” and the “movement region”. For the specific process, reference may be made to the process of determining the movement parameter when the starting position of the touch point of the first touch operation is in the movement region displayed on the graphical user interface, which will not be described in detail here.

In step S106, in response to the touch point of the first specified touch operation moving from the first position to a second position and the second position fulfilling a preset condition, a second movement parameter of the controlled virtual object is determined, and the controlled virtual object is controlled to move in the game scene according to the second movement parameter in a case where the first specified touch operation is released.

Due to an inadvertent operation of the player, for example, when the battle is intense and the player needs to make the controlled virtual character reach the maximum speed, the player may move the virtual joystick as far as possible in the direction away from the initial position, and thus the touch point of the first specified touch operation moves outside the movement region, that is, the second position mentioned above. The preset condition may be that when the starting position of the touch point of the first specified touch operation is within the movement region, the second position is outside the movement region of the virtual joystick; or, the preset condition may also be that when the starting position of the touch point of the first specified touch operation is outside the movement region, the second position is outside the “movement region” determined based on the starting position.

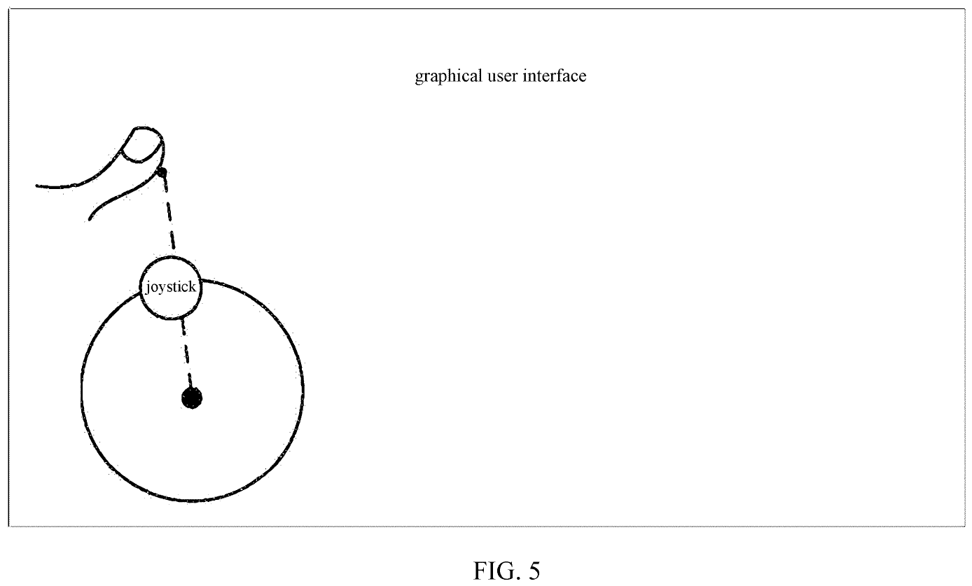

Since the virtual joystick can only move in the movement region, the virtual joystick may be controlled to be displayed at an edge position of the movement region. The edge position may be an edge position when the position of the touch point of the first specified touch operation of the player leaves the movement region, or may be an intersection position of a line connecting the position of the touch point of the first specified touch operation outside the movement region and the initial position and the edge of the movement region, as shown in FIG. 5. The specific setting can be based on the game requirements and is not limited here.

The edge position of the movement region also corresponds to a preset movement parameter, which is referred to as a second movement parameter. At this time, the controlled virtual object may be controlled to move according to the second movement parameter corresponding to the edge position displayed for the virtual joystick.

When the position of the touch point of the first specified touch operation moves outside the movement region, the controlled virtual object moves according to the second movement parameter. When the player releases the first specified touch operation outside the movement region, it can be regarded that the player has discovered that the position of the touch point has exceeded the movement region and is adjusting an operation position of the virtual joystick. In order to facilitate the player to adjust the operation position without interrupting the movement procedure of the controlled virtual object, the controlled virtual object may be controlled to continue to move according to the second movement parameter.

In a specific implementation, the second movement parameter may be restricted. For example, when a player needs to control the controlled virtual object at a relatively fast speed, an inadvertent operation, in which the player controls the touch point position of the first specified touch operation to move outside the movement region, often occurs. When the player releases the first specified touch operation, whether the controlled virtual object moves at the maximum movement speed may be determined. If the controlled virtual object moves at the maximum movement speed, the controlled virtual object is controlled to move according to the current movement parameter. Similarly, the second movement parameter may also be restricted to be a set movement direction, or a set movement speed and movement direction. In this case, the second movement parameter is one or more movement parameters corresponding to the edge position.

In step S108, in response to a second specified touch operation, an adjustment parameter is determined according to the second specified touch operation. The second specified operation and the first specified touch operation are touch operations that are not continuous.

The second specified touch operation may usually be regarded as a touch operation performed again by the player to adjust the operation position of the virtual joystick after the player finds that the position of the touch point has exceeded the movement region. In order to make the movement procedure of the controlled virtual object continuous, when the player performs a pressing operation on the graphical user interface again, a correspondence relationship between the position of the touch point at this time and the current movement speed and/or direction of the controlled virtual object may be established. That is, a correspondence relationship between the starting position of the touch point of the second specified touch operation and the second movement parameter may be established.

As described above, since there is a correspondence relationship between respective region positions of the movement region of the virtual joystick and the movement parameters of the controlled virtual object, it is usually a one-to-one correspondence relationship. In order to facilitate the player to continue to control the movement of the controlled virtual object, the movement region may be updated based on the starting position of the touch point of the second specified touch operation, and then the adjustment parameter for the movement parameter of the controlled virtual object is determined based on the parameters such as the movement direction and movement distance of the touch point of the second specified touch operation in the updated movement region. The correspondence relationship between the region positions and the movement parameters in the movement region is required in this procedure. For example, the movement parameter corresponding to the initial position of the virtual joystick in the movement region is the minimum speed or the speed is zero. If the touch point of the second specified touch operation moves from the starting position to the initial position in the updated movement region, the adjustment parameter may be considered to be a negative value of the second movement parameter.

When controlling the controlled virtual object to move according to the second movement parameter, it can be set that if the player does not perform a touch operation on the virtual joystick within a preset time, the controlled virtual object stops moving over the preset time. In addition, it can also be set that when the player operates the virtual joystick again, the touch point position of the player's touch operation is the edge position corresponding to the second movement parameter, so as to maintain the movement speed and/or movement direction of the controlled virtual object. And, based on the touch point position of the player's touch operation, the display position of the movement control is updated, so as to control the movement of the controlled virtual object based on the touch operation of the player on the updated movement control.

In step S110, a third movement parameter is determined according to the adjustment parameter and the second movement parameter, and the controlled virtual object is controlled to move according to the third movement parameter.

After determining the adjustment parameter for the movement parameter of the controlled virtual object, the third movement parameter of the controlled virtual object may be determined based on the adjustment parameter and the current movement parameter of the controlled virtual object, that is, the second movement parameter. In this procedure, when the movement speed in the movement parameter is a scalar, addition or subtraction of the movement speed may be performed, and when the movement speed is a vector, vector calculation may be performed on the movement speed, so as to determine the third movement parameter of the controlled virtual object and control the controlled virtual object to move according to the third movement parameter.

In the above interaction control method for object movement, in response to the first specified touch operation on the virtual joystick, the virtual joystick is controlled to move according to the movement of the touch point of the operation. The first movement parameter of the controlled virtual object is determined based on the first position of the touch point of the operation, and the object is controlled to move. In response to the touch point of the first specified touch operation moving to the second position and the second position fulfilling the preset condition, the second movement parameter is determined, and the object is controlled to move according to the second movement parameter in a case where the first specified touch operation is released. The adjustment parameter is determined in response to the second specified touch operation. The third movement parameter is determined according to the adjustment parameter and the second movement parameter, and the object is controlled to move according to the third movement parameter. In this way, when the player performs a touch operation on the virtual joystick again for adjusting the touch position, the virtual object is controlled to move based on the target movement parameter, thereby improving the player's experience.

The following embodiments provide a specific method for determining the second movement parameter of the controlled virtual object in response to the touch point of the first specified touch operation moving from the first position to the second position and the second position fulfilling the preset condition, and controlling the controlled virtual object to move in the game scene according to the second movement parameter in a case where the first specified touch operation is released.

The starting position of the touch point of the player's first specified touch operation may fall within the movement region of the virtual joystick displayed on the graphical user interface, or it may fall outside the movement region. In a case where the starting position of the touch point of the player's first specified touch operation falls within the movement region of the virtual joystick, the position of the touch point and the position of the virtual joystick in the graphical user interface usually coincide with each other. Therefore, the position of the touch point of the first specified touch operation refers to both a touch position of a touch medium of the first specified touch operation on the graphical user interface and the position of the virtual joystick in the graphical user interface. When the touch point of the first specified touch operation moves outside the movement region, the position of the touch point of the first specified touch operation usually refers to the touch position of the touch medium on the graphical user interface. The touch medium usually refers to the player's finger, or may also be other device(s) such as a stylus that can be used for touch operation(s). At this time, the first position of the touch point usually refers to a position within the movement region, and the second position of the touch point usually refers to a position outside the movement region or an edge position of the movement region.

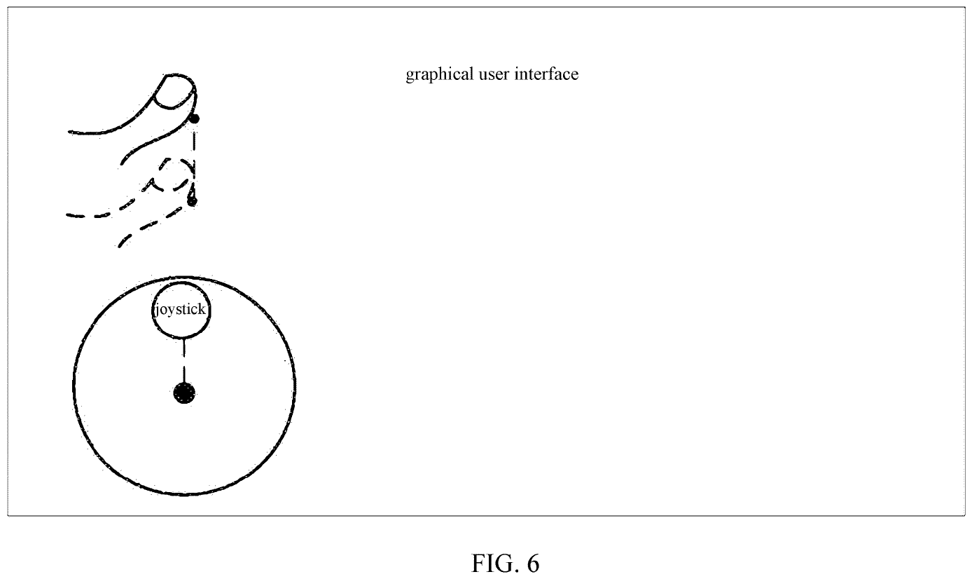

When the starting position of the touch point of the player's first specified touch operation falls outside the movement region, the position of the touch point is inconsistent with the position of the virtual joystick in the graphical user interface. As shown in FIG. 6, the touch point generated by the finger represented by a dotted line is located at the initial position, and the touch point generated by the finger represented by a solid line is a touch point after movement. The line between the two fingers represents a movement trajectory of the touch point, and a dotted line in the movement region represents a movement trajectory generated by the virtual joystick following the movement of the touch point. The position of the touch point of the first specified touch operation usually refers to the touch position of the touch medium on the graphical user interface. Based on the above discussions, it can be known that a “movement region” with the starting position as a center may usually be determined based on the starting position of the touch point. The second position fulfilling the preset condition may be that the second position is located outside the determined “movement region”. When the first position refers to the starting position of the touch point, since the “movement region” is determined based on the initial position, the preset condition that the second position needs to fulfill may also be defined by the distance between the first position and the second position. Specifically, the preset condition may be that the distance between the second position and the first position fulfills a preset distance threshold. At this time, the second position is located outside the determined “movement region”.

In addition, some preset conditions may also be set, for example, the duration of the touch point at the second position fulfilling a time threshold and/or the second position being located in a preset position region, etc., to trigger the control mode of controlling the controlled virtual object to move according to the second movement parameter when the first specified touch operation is released. For example, if the player controls the touch point outside the movement region of the virtual joystick for two seconds, the controlled virtual object can be “locked” as moving according to the second movement parameter after the first specified touch operation is released. A lock control may also be displayed in the preset position region of the graphical user interface. When the player moves the touch point to the preset position region, the lock control is triggered, thereby “locking” the controlled virtual object as moving according to the second movement parameter after the first specified touch operation is released.

Correspondingly, the preset condition may be that the second position is outside the movement region. When the player controls the touch point to move from the first position to the second position which is outside the movement region, since the virtual joystick can only move within the movement region, the virtual joystick may be controlled to display at a target edge position in the movement region corresponding to the second position; and based on the target edge position, the second movement parameter of the controlled virtual object is determined.

In a specific implementation, the movement region usually has an initial position. The initial position is a display position of the virtual joystick when no touch operation is generated on the virtual joystick. As shown in FIG. 2 to FIG. 4, the initial positions in various different movement regions are marked. The first specified touch operation may be a first sliding operation with the initial position as a starting point, and the second position is a position outside the movement region. In response to the touch point of the first specified touch operation moving from the first position to the second position, an intersection point of a line connecting the second position and the initial position and an edge of the movement region is determined as the target edge position corresponding to the second position. The virtual joystick is controlled to be displayed at the target edge position in the movement region corresponding to the second position. In the above case, when the touch point of the first sliding operation moves outside the movement region, if the operation changes the intersection point of the connection line and the edge of the movement region, the movement parameter of the controlled virtual object will also be changed.

In a specific implementation, the second movement parameter may include a target movement speed. When the target movement speed is the maximum speed among the movement speeds corresponding to the region positions in the movement region, that is, the target movement speed corresponding to the edge position is greater than the movement speeds corresponding to the region positions except the edge position in the movement region, the controlled virtual object may be controlled to move according to the target movement speed. Generally speaking, within the movement region, the farther a region position is from the initial position, the greater the movement speed corresponding to the region position. As shown in FIG. 2, the movement speed corresponding to the edge position of the circular region is the maximum speed.

In a specific implementation, a time length may be preset, which may be referred to as a preset time length. After the first specified touch operation is released outside the movement region, the controlled virtual object is controlled to move according to the second movement parameter within the preset time length. If the time length is exceeded, the controlled virtual object may be controlled to stop moving.

The following embodiments provide a specific method for determining the adjustment parameter according to the second specified touch operation in response to the second specified touch operation.

After the first specified touch operation is released, the player usually needs to adjust the operation position of the virtual joystick. The second specified touch operation may be composed of a pressing operation and a sliding operation continuous with the pressing operation. When the player performs a pressing operation on the graphical user interface, in response to the pressing operation, displaying of the movement control is updated based on a third position of the touch point of the pressing operation. The touch point of the pressing operation is located in the updated movement region. In response to a sliding operation with the third position of the touch point of the pressing operation as a starting position, the adjustment parameter is determined according to the touch point of the sliding operation. The sliding operation usually acts on the updated movement region.

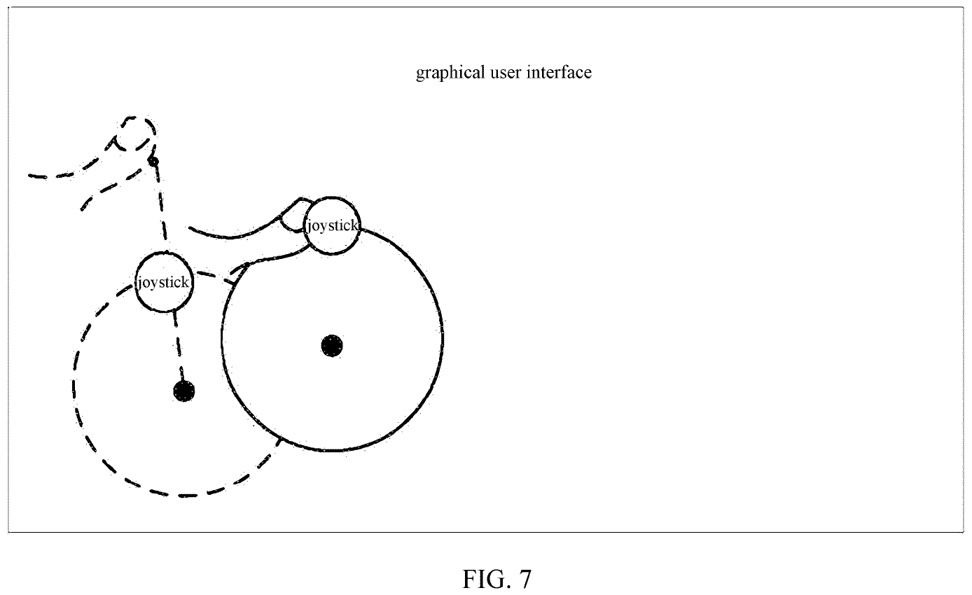

When updating the displaying of the movement control, in response to the pressing operation, the virtual joystick is displayed at the third position of the touch point of the pressing operation, and based on the third position and the second movement parameter, an updated movement region is displayed. Specifically, the third position may be determined as ta region position of the updated movement region corresponding to the second movement parameter. Based on a preset positional relationship between the movement region and the region position corresponding to the second movement parameter, displaying of the movement region is updated. As shown in FIG. 7, the circular region represented by the dotted line is the movement region before the update, the circular region represented by the solid line is the movement region after the update, the finger represented by the dotted line is the player's finger before the update, and the finger represented by the solid line is the player's finger after the update.

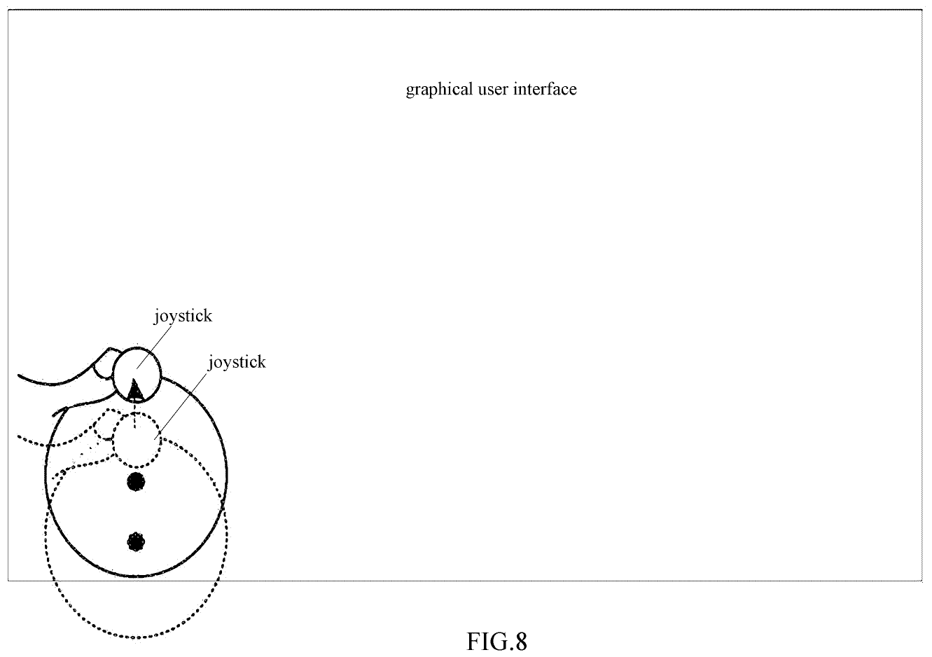

After updating the movement region, the updated movement region may have a partial region outside the graphical user interface. At this time, whether the updated movement region includes a partial region outside the graphical user interface may be determined; if the updated movement region includes the partial region outside the graphical user interface, a target sliding direction is determined based on a relative positional relationship between the partial region and the graphical user interface. Specifically, if the partial region is located below the graphical user interface, the target sliding direction is upward; in response to a sliding operation sliding in the target sliding direction with the third position of the touch point of the pressing operation as the starting point, the display position of the movement region is controlled to move following the position of the touch point of the second sliding operation. When the player performs an upward sliding operation, the display position of the movement region also slides upward, and the movement region can be fully displayed on the graphical user interface, as shown in FIG. 8. Then, in response to the updated movement region moving to be within the graphical user interface, the adjustment parameter is determined according to the touch point of the sliding operation and the updated movement region. Specifically, the method of determining the adjustment parameter for the movement parameter according to the sliding operation in the movement region is similar with the method before the movement control is updated, and will not be repeated here.

In a specific implementation, a time threshold may be set. When the player performs the pressing operation in the second specified touch operation on the graphical user interface, in response to the pressing operation, whether a time difference between a time when the second specified touch operation is generated and a time when the first specified touch operation is released is smaller than or equal to a preset time threshold may be determined first; if the time difference is greater than the preset time threshold, it is considered that the player is not adjusting the operation position, but needs to re-control the controlled virtual object to move, and the updating of displaying of the movement control is canceled.

An embodiment of the present disclosure also provides another interaction control method for object movement. This method is implemented on the basis of the method shown in FIG. 1. This method allows a player to be free to “reset” the position of the virtual joystick dragged by the finger in a scenario where continuous movement and speed are required, without interrupting the control of the movement speed and movement direction of a controlled virtual character, and the movement speed at this time is the maximum movement speed.

When a player drags the virtual joystick through a sliding operation and control the controlled virtual object to reach the maximum speed, the touch point is usually at the edge of the movement region of the virtual joystick. However, since there is no physical maximum control value perception like a handle or a keyboard and a mouse, it is common for the finger to continue to drag the virtual joystick upwards in an attempt to continue accelerating, causing the finger to move to an uncomfortable position and possibly block some key information in the game.

In order to avoid the competition burden caused by raising the player's hand to adjust the position to cause deceleration, after the player adjusts the position of his/her finger and releases the operation on the virtual joystick, the controlled virtual object continues to move at the maximum speed and in the original direction. When the player touches the screen again, the virtual joystick remains at the original maximum speed and in the original direction.

The following is a supplement to the details of the method:
1. When the controlled virtual object moves at a non-maximum speed, that is, when the virtual joystick is pushed back, if the player releases his/her finger and touches the screen again, the original state of the centered joystick is retained, making it easier for the player to leave the maximum speed state.
2. When the control is maintained at a state of the maximum speed and direction, the new position of the thumb may cause the movement region (also called a “response region”) of the joystick to go outside the screen, thus affecting the dragging range of the joystick. When the movement region of the joystick goes outside the screen, the following method(s) may be used to ensure that there is enough space for the joystick control to be dragged downwards:
a. If a finger continues to move up or right, the control moves into the screen in the direction to ensure a movement operation in other direction(s).
b. When the finger moves downward, it automatically breaks out of the prerequisite of “movement at maximum speed”. It is considered by default that the player no longer has a demand for the maximum speed. If the operation remains unchanged at this time, when the finger leaves the screen and touches the screen again, the joystick state returns to the normal scheme, that is, the joystick touch point is centered in the joystick response region, and the speed returns to zero, thereby ensuring that there is enough space for downward movement.
c. When the finger moves to the left, this situation is not handled, because the player's “reset” action in the above scene is more of a change on the Y axis, not the X axis. Therefore, resetting does not affect the space for moving to the left.

In racing scenarios, this method does not interrupt the maximum movement speed state, allowing a player to be free to “reset” the finger grip position, and reduces competitive disadvantages caused by the thumb blocking key information in the game scene and uncomfortable grip gesture.

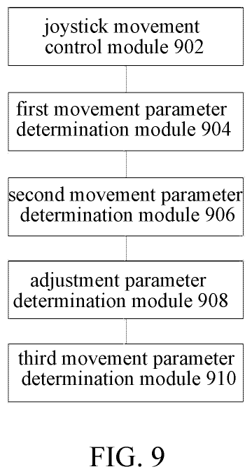

Corresponding to the above method embodiments, referring to FIG. 9, an interaction control apparatus for object movement is provided. A graphical user interface is provided through a terminal device. A game scene where a controlled virtual object is located and a movement control are displayed on graphical user interface. The movement control includes a virtual joystick and a movement region of the virtual joystick. The movement region is used to limit a movement range of the virtual joystick. The apparatus includes:
a joystick movement control module 902 configured to, in response to a first specified touch operation on the virtual joystick, control the virtual joystick to move within the movement range according to movement of a touch point of the first specified touch operation;
a first movement parameter determination module 904 configured to determine a first movement parameter of the controlled virtual object based on a first position of the touch point of the first specified touch operation, and control the controlled virtual object to move in the game scene according to the first movement parameter, wherein the first movement parameter includes a movement speed and/or a movement direction;
a second movement parameter determination module 906 configured to, in response to the touch point of the first specified touch operation moving from the first position to a second position and the second position fulfilling a preset condition, determine a second movement parameter of the controlled virtual object, and control the controlled virtual object to move in the game scene according to the second movement parameter in a case where the first specified touch operation is released;
an adjustment parameter determination module 908 configured to, in response to a second specified touch operation, determine an adjustment parameter according to the second specified touch operation, wherein the second specified operation and the first specified touch operation are touch operations that are not continuous;
a third movement parameter determination module 910 configured to determine a third movement parameter according to the adjustment parameter and the second movement parameter, and control the controlled virtual object to move according to the third movement parameter.

In response to the first specified touch operation on the virtual joystick, the movement of the virtual joystick is controlled according to the movement of the touch point of the operation. Based on the first position of the touch point of the operation, the first movement parameter of the controlled virtual object is determined, and the object is controlled to move. In response to the touch point of the first specified touch operation moving to the second position and the second position fulfilling the preset condition, the second movement parameter is determined, and in a case where the first specified touch operation is released, the object is controlled to move with the second movement parameter. In response to the second specified touch operation, the adjustment parameter is determined. According to the adjustment parameter and the second movement parameter, a third movement parameter is determined, and the object is controlled to move with the third movement parameter. In this way, when the player performs a touch operation on the virtual joystick again because the player adjusts the touch position, the virtual object is controlled to move based on the target movement parameter, thereby improving the player's experience.

In some embodiments, the second position fulfilling the preset condition includes at least one of the following: a distance between the second position and the first position fulfilling a preset distance threshold; a duration of the touch point at the second position fulfilling a time threshold; or the second position being located in a preset position region.

In some embodiments, the position of the touch point of the first specified touch operation is at least one of: a touch position of a touch medium of the first specified touch operation on the graphical user interface; or a position of the virtual joystick in the graphical user interface.

In some embodiments, the second movement parameter determination module is further configured to: in response to the touch point of the first specified touch operation moving from the first position to the second position and the second position fulfilling the preset condition, control the virtual joystick to be displayed at a target edge position corresponding to the second position in the movement region; and based on the target edge position, determine the second movement parameter of the controlled virtual object.

In some embodiments, the movement region includes an initial position; the second movement parameter determination module is further configured to: in response to the touch point of the first specified touch operation moving from the first position to the second position, determine an intersection point of a line connecting the second position and the initial position and an edge of the movement region as the target edge position corresponding to the second position; and control the virtual joystick to be displayed at the target edge position corresponding to the second position in the movement region.

In some embodiments, the second movement parameter determination module is further configured to: in response to a pressing operation, update displaying of the movement control based on a third position of the touch point of the pressing operation, wherein the touch point of the pressing operation is located in the updated movement region; and in response to a sliding operation with a third touch point of the touch point of the pressing operation as a starting point, determine the adjustment parameter according to a touch point of the sliding operation.

In some embodiments, the second movement parameter determination module is further configured to: in response to a pressing operation, display the virtual joystick at a third position of the touch point of the pressing operation, and display an updated movement region based on the third position and the second movement parameter.

In some embodiments, the second movement parameter determination module is further configured to: determine the third position as a region position of the updated movement region corresponding to the second movement parameter; and update displaying of the movement region based on a preset positional relationship between the movement region and the region position corresponding to the second movement parameter.

In some embodiments, the adjustment parameter determination module is further configured to: determine whether the updated movement region includes a partial region outside the graphical user interface; if the updated movement region includes the partial region outside the graphical user interface, determine a target sliding direction based on a relative positional relationship between the partial region and the graphical user interface; in response to a sliding operation with the third position of the touch point of the pressing operation as a starting point and sliding in the target sliding direction, control the display position of the movement region to move following the position of the touch point of the sliding operation; and in response to the updated movement region moving into the graphical user interface, determine the adjustment parameter according to the touch point of the sliding operation and the updated movement region.

In some embodiments, the second movement parameter determination module is further configured to: in response to the controlled virtual object moving according to the second movement parameter and the touch point of the first specified touch operation being released outside the movement region, control the controlled virtual object to move in the game scene according to the second movement parameter within a preset time length.

In some embodiments, the interaction control apparatus for object movement further includes: a time difference determination module configure to, in response to a pressing operation, determine whether a time difference between a time when the pressing operation is generated and a time when the first specified touch operation is released is smaller than or equal to a preset time threshold; and a movement control update cancellation module configure to cancel updating of displaying of the movement control if the time difference is not smaller than or equal to a preset time threshold.

An embodiment further provides an electronic device, including a processor and a memory. The memory stores machine executable instructions that can be executed by the processor. The processor executes the machine executable instructions to implement the above-mentioned interaction control methods for object movement, for example:
in response to a first specified touch operation on a virtual joystick, controlling the virtual joystick to move within a movement range according to movement of a touch point of the first specified touch operation; based on a first position of the touch point of the first specified touch operation, determining a first movement parameter of the controlled virtual object, and controlling the controlled virtual object to move in a game scene according to the first movement parameter, wherein the first movement parameter includes a movement speed and/or a movement direction; in response to the touch point of the first specified touch operation moving from a first position to a second position and the second position fulfilling a preset condition, determining a second movement parameter of the controlled virtual object, and controlling the controlled virtual object to move in the game scene according to the second movement parameter in a case where the first specified touch operation is released; in response to a second specified touch operation, determining an adjustment parameter according to the second specified touch operation, wherein the second specified operation and the first specified touch operation are touch operations that are not continuous; determining a third movement parameter according to the adjustment parameter and the second movement parameter, and controlling the controlled virtual object to move according to the third movement parameter.

When the player performs a touch operation on the virtual joystick again because the payer adjusts the touch position, the virtual object is controlled to move based on the target movement parameter, thereby improving the player's experience.

In some embodiments, the second position fulfilling the preset condition includes at least one of the following: a distance between the second position and the first position fulfilling a preset distance threshold; a duration of a touch point at the second position fulfilling a time threshold; and the second position being located in a preset position region.

In some embodiments, the position of the touch point of the first specified touch operation is at least one of: a touch position of a touch medium of the first specified touch operation on the graphical user interface; and a position of the virtual joystick in the graphical user interface.

In some embodiments, the step of determining the second movement parameter of the controlled virtual object in response to the touch point of the first specified touch operation moving from the first position to the second position and the second position fulfilling the preset condition, includes: in response to the touch point of the first specified touch operation moving from the first position to the second position and the second position fulfilling the preset condition, controlling the virtual joystick to be displayed at a target edge position corresponding to the second position in the movement region; and based on the target edge position, determining the second movement parameter of the controlled virtual object.

In some embodiments, the movement region includes an initial position; the step of controlling the virtual joystick to be displayed at the target edge position corresponding to the second position in the movement region in response to the touch point of the first specified touch operation moving from the first position to the second position and the second position fulfilling the preset condition, includes: in response to the touch point of the first specified touch operation moving from the first position to the second position, determining an intersection point of a line connecting the second position and the initial position and an edge of the movement region as the target edge position corresponding to the second position; and controlling the virtual joystick to be displayed at the target edge position corresponding to the second position in the movement region.

In some embodiments, the step of determining the adjustment parameter according to the second specified touch operation in response to the second specified touch operation, includes: in response to a pressing operation, updating displaying of the movement control based on a third position of a touch point of the pressing operation, wherein the touch point of the pressing operation is located in the updated movement region; and in response to a sliding operation with the third touch point of the touch point of the pressing operation as the starting point, determining the adjustment parameter according to the touch point of the sliding operation.

In some embodiments, the step of updating displaying of the movement control based on the third position of the touch point of the pressing operation in response to the pressing operation, includes: in response to the pressing operation, displaying the virtual joystick at the third position of the touch point of the pressing operation, and displaying an updated movement region based on the third position and the second movement parameter.

In some embodiments, the step of displaying the updated movement region based on the third position and the second movement parameter includes: determining the third position as a region position of the updated movement region corresponding to the second movement parameter; and updating the displaying of the movement region based on a preset positional relationship between the movement region and the region position corresponding to the second movement parameter.

In some embodiments, the step of determining the adjustment parameter based on the touch point of the sliding operation in response to the sliding operation with the touch point of the pressing operation as the starting point, includes: determining whether the updated movement region includes a partial region outside the graphical user interface; if the updated movement region includes the partial region outside the graphical user interface, determining a target sliding direction based on a relative positional relationship between the partial region and the graphical user interface; in response to a sliding operation with a third position of the touch point of the pressing operation as the starting point and sliding in the target sliding direction, controlling a display position of the movement region to move following the position of the touch point of the sliding operation; and in response to the updated movement region moving into the graphical user interface, determining the adjustment parameter based on the touch point of the sliding operation and the updated movement region.

In some embodiments, the step of controlling the controlled virtual object to move in the game scene according to second movement parameter in a case where the first specified touch operation is released includes: in response to the controlled virtual object moving according to the second movement parameter and the touch point of the first specified touch operation being released outside the movement region, controlling the controlled virtual object to move in the game scene according to the second movement parameter within a preset time length.

In some embodiments, the interaction control method for object movement further includes: in response to a pressing operation, determining whether a time difference between a time when the pressing operation is generated and a time when the first specified touch operation is released is smaller than or equal to a preset time threshold; if the time difference is not smaller than or equal to the preset time threshold, canceling the updating of displaying of the movement control.

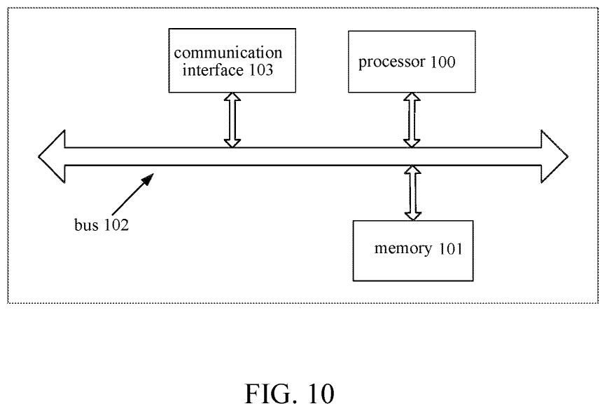

As shown in FIG. 10, the electronic device includes a processor 100 and a memory 101. The memory 101 stores machine executable instructions that can be executed by the processor 100. The processor 100 executes the machine executable instructions to implement the above-mentioned interaction control methods for object movement.

Furthermore, the electronic device shown in FIG. 10 further includes a bus 102 and a communication interface 103, and the processor 100, the communication interface 103 and the memory 101 are connected via the bus 102.

The memory 101 may include a high-speed Random Access Memory (RAM), and may also include a non-volatile memory, such as at least one magnetic disk storage. The communication connection between the system network element and at least one other network element is realized through at least one communication interface 103 (which may be wired or wireless), and the Internet, wide area network, local area network, metropolitan area network, etc. may be used. The bus 102 may be an ISA bus, a PCI bus or an EISA bus, etc. The bus may be divided into an address bus, a data bus, a control bus, etc. For ease of representation, only one bidirectional arrow is used in FIG. 10, but it does not mean that there is only one bus or one type of bus.

The processor 100 may be an integrated circuit chip with signal processing capabilities. In the implementations, each step of the above methods may be completed by the hardware integrated logic circuit or instructions in a form of software in the processor 100. The processor 100 may be a general-purpose processor, including a Central Processing Unit (CPU), a Network Processor (NP), etc., the processor 101 may also be a Digital Signal Processor (DSP), an Application Specific Integrated Circuit (ASIC), a Field-Programmable Gate Array (FPGA) or other programmable logic device(s), a discrete gate or a transistor logic device, a discrete hardware component. The methods, steps and logic block diagrams disclosed in the embodiments of the present disclosure may be implemented or carried out. The general-purpose processor may be a microprocessor or the processor may also be any conventional processor, etc. The steps of the methods disclosed in conjunction with the embodiments of the present disclosure may be directly embodied as being performed by a hardware decoding processor, or may be embodied as being performed by a combination of hardware and software modules in the decoding processor. The software module may be located in a mature storage medium in the art, such as a random access memory, a flash memory, a read-only memory, a programmable read-only memory or an electrically erasable programmable memory, a register, etc. The storage medium is located in the memory 101, and the processor 100 reads information in the memory 101, and completes the steps of the methods of the aforementioned embodiments in combination with its hardware.

An embodiment also provides a machine-readable storage medium. The machine-readable storage medium stores machine-executable instructions. When the machine-executable instructions are invoked and executed by a processor, the machine-executable instructions cause the processor to implement the above-mentioned interaction control methods for object movement.

In the interaction control method and apparatus for object movement and the electronic device provided by embodiments of the present disclosure, a computer-readable storage medium storing a program code is included. The program code includes instructions that can be used to implement the methods described in the above method embodiments, for example:
in response to a first specified touch operation on a virtual joystick, controlling the virtual joystick to move within a movement range according to movement of a touch point of the first specified touch operation; based on a first position of the touch point of the first specified touch operation, determining a first movement parameter of the controlled virtual object, and controlling the controlled virtual object to move in a game scene according to the first movement parameter, wherein the first movement parameter includes a movement speed and/or a movement direction; in response to the touch point of the first specified touch operation moving from the first position to a second position and the second position fulfilling a preset condition, determining a second movement parameter of the controlled virtual object, and controlling the controlled virtual object to move in the game scene according to the second movement parameter in a case where the first specified touch operation is released; in response to a second specified touch operation, determining an adjustment parameter according to the second specified touch operation, wherein the second specified operation and the first specified touch operation are touch operations that are not continuous; determining a third movement parameter according to the adjustment parameter and the second movement parameter, and controlling the controlled virtual object to move according to the third movement parameter.

When the player performs a touch operation on the virtual joystick again because the player adjusts the touch position, the virtual object is controlled to move based on the target movement parameter, thereby improving the player's experience.

In some embodiments, the second position fulfilling the preset condition includes at least one of the following: a distance between the second position and the first position fulfilling a preset distance threshold; a duration of a touch point at the second position fulfilling a time threshold; and the second position being located in a preset position region.

In some embodiments, the position of the touch point of the first specified touch operation is at least one of: a touch position of a touch medium of the first specified touch operation on the graphical user interface; and a position of the virtual joystick in the graphical user interface.

In some embodiments, the step of determining the second movement parameter of the controlled virtual object in response to the touch point of the first specified touch operation moving from the first position to the second position and the second position fulfilling the preset condition, includes: in response to the touch point of the first specified touch operation moving from the first position to the second position and the second position fulfilling the preset condition, controlling the virtual joystick to be displayed at a target edge position corresponding to the second position in the movement region; and based on the target edge position, determining the second movement parameter of the controlled virtual object.

In some embodiments, the movement region includes an initial position; the step of controlling the virtual joystick to be displayed at the target edge position corresponding to the second position in the movement region in response to the touch point of the first specified touch operation moving from the first position to the second position and the second position fulfilling the preset condition, includes: in response to the touch point of the first specified touch operation moving from the first position to the second position, determining an intersection point of a line connecting the second position and the initial position and an edge of the movement region as the target edge position corresponding to the second position; and controlling the virtual joystick to be displayed at the target edge position corresponding to the second position in the movement region.

In some embodiments, the step of determining the adjustment parameter according to the second specified touch operation in response to a second specified touch operation, includes: in response to a pressing operation, updating displaying of the movement control based on a third position of a touch point of the pressing operation, wherein the touch point of the pressing operation is located in the updated movement region; in response to a sliding operation with the third touch point of the touch point of the pressing operation as the starting point, determining the adjustment parameter according to the touch point of the sliding operation.

In some embodiments, the step of updating displaying of the movement control based on the third position of the touch point of the pressing operation in response to the pressing operation, includes: in response to the pressing operation, displaying the virtual joystick at the third position of the touch point of the pressing operation, and displaying an updated movement region based on the third position and the second movement parameter.

In some embodiments, the step of displaying the updated movement region based on the third position and the second movement parameter includes: determining the third position as a region position of the updated movement region corresponding to the second movement parameter; and updating the displaying of the movement region based on a preset positional relationship between the movement region and the region position corresponding to the second movement parameter.

In some embodiments, the step of determining the adjustment parameter based on the touch point of the sliding operation in response to the sliding operation with the touch point of the pressing operation as the starting point, includes: determining whether the updated movement region includes a partial region outside the graphical user interface; if the updated movement region includes the partial region outside the graphical user interface, determining a target sliding direction based on a relative positional relationship between the partial region and the graphical user interface; in response to a sliding operation with the third position of the touch point of the pressing operation as the starting point and sliding in the target sliding direction, controlling a display position of the movement region to move following the position of the touch point of the sliding operation; and in response to the updated movement region moving into the graphical user interface, determining the adjustment parameter based on the touch point of the sliding operation and the updated movement region.

In some embodiments, the step of controlling the controlled virtual object to move in the game scene according to second movement parameter in a case where the first specified touch operation is released includes: in response to the controlled virtual object moving according to the second movement parameter and the touch point of the first specified touch operation being released outside the movement region, controlling the controlled virtual object to move in the game scene according to the second movement parameter within a preset time length.

In some embodiments, the interaction control method for object movement also includes: in response to a pressing operation, determining whether a time difference between a time when the pressing operation is generated and a time when the first specified touch operation is released is smaller than or equal to a preset time threshold; if the time difference is not smaller than or equal to the preset time threshold, canceling updating of the displaying of the movement control.

Those skilled in the art can clearly understand that, for the convenience and brevity of description, regarding the specific working processes of the systems and apparatuses described above, reference can be made to the corresponding processes in the aforementioned method embodiments, and repeated descriptions will be omitted here.

In addition, in the description of the embodiments of the present disclosure, unless otherwise clearly specified and limited, the terms “installed/installment”, “connected/connection”, and “coupled/coupling” should be understood in a broad sense, for example, it can be a fixed connection, a detachable connection, or an integral connection; it can be a mechanical connection or an electrical connection; it can be a direct connection, or it can be indirect connection through an intermediate medium, or it can be an internal communication of two components. For those skilled in the art, the specific meanings of the above terms in the present disclosure can be understood according to specific circumstances.

If the functions are implemented in the form of software functional units and sold or used as an independent product, they may be stored in a computer-readable storage medium. Based on this understanding, the technical solutions of the present disclosure, or the part that contributes to the prior art or the part of the technical solutions, may be embodied in the form of a software product. The computer software product is stored in a storage medium, including a plurality of instructions to cause a computer device (which may be a personal computer, a server, or a network device, etc.) to perform all or a part of the steps of the methods described in the embodiments of the present disclosure. The storage medium includes various types of mediums that can store program codes, such as, a U disk, a mobile hard disk, a Read-Only Memory (ROM), a Random Access Memory (RAM), a magnetic disk or an optical disk, etc.

In the description of the present disclosure, it should be noted that the terms “center”, “upper”, “lower”, “left”, “right”, “vertical”, “horizontal”, “inner”, “outer”, etc., indicating the orientation or positional relationships, are based on the orientation or positional relationships shown in the drawings, and are only for the convenience of describing the present disclosure and simplifying the description, rather than indicating or implying that the mentioned apparatus(apparatuses) or element(s) must have a specific orientation or must be constructed and operated in a specific orientation, and therefore these terms cannot be understood as a limitation of the present disclosure. In addition, the terms “first”, “second”, and “third” are used for descriptive purposes only, and cannot be understood as indicating or implying relative importance.

Finally, it should be noted that the above-described embodiments are only example implementations of the present disclosure, which are used to illustrate the technical solutions of the present disclosure, rather than to limit the present disclosure. The protection scope of the present disclosure is not limited to the embodiments described herein. Although the present disclosure is described in detail with reference to the above-described embodiments, those of ordinary skill in this art should understand that any technician familiar with the technical field can still modify the technical solutions in the above-described embodiments within the technical scope disclosed in the present disclosure, or can easily think of changes, or make equivalent replacements for some of the technical features described herein; and these modifications, changes or replacements do not make the essence of corresponding technical solutions deviate from the spirit and scope of the technical solutions of the embodiments of the present disclosure, and should be included in the protection scope of the present disclosure. Therefore, the protection scope of the present disclosure should be determined by the protection scope of the claims.

1. An interaction control method for object movement, wherein the method comprises:
in response to a first specified touch operation on a virtual joystick displayed on a graphical user interface provided through a terminal device, controlling the virtual joystick to move within a movement range of the virtual joystick according to movement of a touch point of the first specified touch operation;
based on a first position of the touch point of the first specified touch operation, determining a first movement parameter of a controlled virtual object, and controlling the controlled virtual object to move in a game scene where the controlled virtual is located according to the first movement parameter, wherein the first movement parameter comprises at least one of a movement speed or a movement direction;
in response to the touch point of the first specified touch operation moving from the first position to a second position and the second position fulfilling a preset condition, determining a second movement parameter of the controlled virtual object, and controlling the controlled virtual object to move in the game scene according to the second movement parameter wherein response to the first specified touch operation being released;
in response to a second specified touch operation, determining an adjustment parameter according to the second specified touch operation, wherein the second specified touch operation and the first specified touch operation are touch operations that are not continuous; and
determining a third movement parameter according to the adjustment parameter and the second movement parameter, and controlling the controlled virtual object to move according to the third movement parameter.

2. The method according to claim 1, wherein the second position fulfilling the preset condition at least comprises one of:
a distance between the second position and the first position fulfilling a preset distance threshold; a duration of the touch point at the second position fulfilling a time threshold; or the second position being located in a preset position region.

3. The method according to claim 2, wherein a position of the touch point of the first specified touch operation is at least one of the following:
a touch position of a touch medium of the first specified touch operation on the graphical user interface; or a position of the virtual joystick in the graphical user interface.

4. The method according to claim 1, wherein determining the second movement parameter of the controlled virtual object in response to the touch point of the first specified touch operation moving from the first position to the second position and the second position fulfilling the preset condition, comprises:
in response to the touch point of the first specified touch operation moving from the first position to the second position and the second position fulfilling the preset condition, controlling the virtual joystick to be displayed at a target edge position corresponding to the second position in a movement region of the virtual joystick, wherein the movement region is used to limit the movement range of the virtual joystick; and
based on the target edge position, determining the second movement parameter of the controlled virtual object.

5. The method according to claim 4, wherein the movement region comprises an initial position;
wherein controlling the virtual joystick to be displayed at the target edge position corresponding to the second position in the movement region in response to the touch point of the first specified touch operation moving from the first position to the second position and the second position fulfilling the preset condition, comprises:
in response to the touch point of the first specified touch operation moving from the first position to the second position, determining an intersection point of a line connecting the second position and the initial position and an edge of the movement region as the target edge position corresponding to the second position; and
controlling the virtual joystick to be displayed at the target edge position corresponding to the second position in the movement region.

6. The method according to claim 1, wherein determining the adjustment parameter according to the second specified touch operation in response to the second specified touch operation, comprises:
in response to a pressing operation, updating displaying of the movement control based on a third position of a touch point of the pressing operation, wherein the touch point of the pressing operation is located in an updated movement region; and
in response to a sliding operation with the third position of the touch point of the pressing operation as a starting point, determining the adjustment parameter according to a touch point of the sliding operation.

7. The method according to claim 6, wherein updating displaying of the movement control based on the third position of the touch point of the pressing operation in response to the pressing operation, comprises:
in response to the pressing operation, displaying the virtual joystick at the third position of the touch point of the pressing operation, and displaying the updated movement region displayed based on the third position and the second movement parameter.

8. The method according to claim 7, wherein displaying the updated movement region based on the third position and the second movement parameter comprises:
determining the third position as a region position of the updated movement region corresponding to the second movement parameter; and
based on a preset positional relationship between the movement region and the region position corresponding to the second movement parameter, updating displaying of the movement region.

9. The method according to claim 6, wherein the step of determining the adjustment parameter according to the touch point of the sliding operation in response to the sliding operation starting with the third position of the touch point of the pressing operation as the starting point, comprises:
determining whether the updated movement region comprises a partial region outside the graphical user interface;
in response to the updated movement region comprising the partial region outside the graphical user interface, determining a target sliding direction based on a relative positional relationship between the partial region and the graphical user interface;
in response to the sliding operation sliding in the target sliding direction with the third position of the touch point of the pressing operation as the starting point, controlling a display position of the movement region to move following a position of the touch point of the sliding operation; and
in response to the updated movement region moving to be within the graphical user interface, determining the adjustment parameter according to the touch point of the sliding operation and the updated movement region.

10. The method according to claim 1, wherein controlling the controlled virtual object to move in the game scene according to the second movement parameter in a case where the first specified touch operation is released comprises:
in response to the controlled virtual object moving according to the second movement parameter and the touch point of the first specified touch operation being released outside the movement region, controlling the controlled virtual object to move in the game scene according to the second movement parameter within a preset time length.

11. The method according to claim 6, further comprising:
in response to the pressing operation, determining whether a time difference between a time when the pressing operation is generated and a time when the first specified touch operation is released is smaller than or equal to a preset time threshold; and
in response to the time difference being not smaller than or equal to the preset time threshold, cancelling the updating of displaying of the movement control.

12. (canceled)

13. An electronic device, comprising a processor and a memory, wherein the memory stores machine executable instructions that can be executed by the processor, and when the processor executes the machine executable instructions, the processor is caused to:
in response to a first specified touch operation on a virtual joystick displayed on a graphical user interface provided through a terminal device, control the virtual joystick to move within a movement range of the virtual joystick according to movement of a touch point of the first specified touch operation;
based on a first position of the touch point of the first specified touch operation, determine a first movement parameter of a controlled virtual object, and control the controlled virtual object to move in a game scene where the controlled virtual is located according to the first movement parameter, wherein the first movement parameter comprises at least one of a movement speed or a movement direction;
in response to the touch point of the first specified touch operation moving from the first position to a second position and the second position fulfilling a preset condition, determine a second movement parameter of the controlled virtual object, and control the controlled virtual object to move in the game scene according to the second movement parameter in response to the first specified touch operation being released;
in response to a second specified touch operation, determine an adjustment parameter according to the second specified touch operation, wherein the second specified touch operation and the first specified touch operation are touch operations that are not continuous; and
determine a third movement parameter according to the adjustment parameter and the second movement parameter, and control the controlled virtual object to move according to the third movement parameter.

14. A non-transitory machine-readable storage medium storing machine-executable instructions, wherein when the machine-executable instructions are invoked and executed by a processor, the machine-executable instructions cause the processor to:
in response to a first specified touch operation on a virtual joystick displayed on a graphical user interface provided through a terminal device, control the virtual joystick to move within a movement range of the virtual joystick according to movement of a touch point of the first specified touch operation;
based on a first position of the touch point of the first specified touch operation, determine a first movement parameter of a controlled virtual object, and control the controlled virtual object to move in a game scene where the controlled virtual is located according to the first movement parameter, wherein the first movement parameter comprises at least one of a movement speed or a movement direction;
in response to the touch point of the first specified touch operation moving from the first position to a second position and the second position fulfilling a preset condition, determine a second movement parameter of the controlled virtual object, and control the controlled virtual object to move in the game scene according to the second movement parameter in response to the first specified touch operation being released;
in response to a second specified touch operation, determine an adjustment parameter according to the second specified touch operation, wherein the second specified touch operation and the first specified touch operation are touch operations that are not continuous; and
determine a third movement parameter according to the adjustment parameter and the second movement parameter, and control the controlled virtual object to move according to the third movement parameter.

15. The method according to claim 1, wherein the second movement parameter comprises a target movement speed, and the target movement speed is a maximum speed among movement speeds corresponding to positions in a movement region of the virtual joystick;
wherein controlling the controlled virtual object to move in the game scene according to the second movement parameter comprises:
controlling the controlled virtual object to move in the game scene according to the maximum speed.

16. The method according to claim 6, wherein the sliding operation is continuous with the pressing operation.

17. The electronic device according to claim 13, wherein the second position fulfilling the preset condition at least comprises one of:
a distance between the second position and the first position fulfilling a preset distance threshold; a duration of the touch point at the second position fulfilling a time threshold; or the second position being located in a preset position region.

18. The electronic device according to claim 17, wherein a position of the touch point of the first specified touch operation is at least one of the following:
a touch position of a touch medium of the first specified touch operation on the graphical user interface; or a position of the virtual joystick in the graphical user interface.

19. The electronic device according to claim 13, wherein when the processor executes the machine executable instructions, the processor is caused to:
in response to the touch point of the first specified touch operation moving from the first position to the second position and the second position fulfilling the preset condition, control the virtual joystick to be displayed at a target edge position corresponding to the second position in a movement region of the virtual joystick, wherein the movement region is used to limit the movement range of the virtual joystick; and
based on the target edge position, determine the second movement parameter of the controlled virtual object.

20. The electronic device according to claim 19, wherein the movement region comprises an initial position;
wherein when the processor executes the machine executable instructions, the processor is caused to:
in response to the touch point of the first specified touch operation moving from the first position to the second position, determine an intersection point of a line connecting the second position and the initial position and an edge of the movement region as the target edge position corresponding to the second position; and
control the virtual joystick to be displayed at the target edge position corresponding to the second position in the movement region.

21. The electronic device according to claim 13, wherein when the processor executes the machine executable instructions, the processor is caused to:
in response to a pressing operation, update displaying of the movement control based on a third position of a touch point of the pressing operation, wherein the touch point of the pressing operation is located in an updated movement region; and
in response to a sliding operation with the third position of the touch point of the pressing operation as a starting point, determine the adjustment parameter according to a touch point of the sliding operation.
